(19) United States
(12) Patent Application Publication
(10) Pub. No.: US 2024/0278232 A1
(43) Pub. Date: Aug. 22, 2024

(54) PREDETERMINED-VOLUME TEST REAGENT BOX

(71) Applicant: Hipro Biotechnology Co., Hayward, CA (US)

(72) Inventors: Lizhu CHEN, Shijiazhuang (CN); Yanjun SUI, Shijiazhuang (CN); Jing WANG, Shijiazhuang (CN)

(73) Assignee: Hipro Biotechnology Co., Hayward, CA (US)

(21) Appl. No.: 18/443,272

(22) Filed: Feb. 15, 2024

(30) Foreign Application Priority Data
Feb. 16, 2023 (CN) 202320235749.9

(51) Int. Cl. B01L 3/00

(52) U.S. Cl. CPC B01L 3/5023; B01L 3/502715; B01L 2200/16; B01L 2300/0877; B01L 2400/0478

(57) ABSTRACT

A predetermined-volume test reagent box is disclosed that includes a main box, a test strip, a suction strip, and an end cover. After taking sample through the sampling head, the end cover is placed at the end of the main box body, and the sampling head is inserted into the piston cap inside the end cover to mix with the reagent. Then, by flipping the main box body and end cover (usually the predetermined-volume chamber is flipped to a vertical state, and the test hole is located at the bottom), the mixed reagent flows into the predetermined-volume chamber through the leakage hole and the mixed reagent contacts the test strip at the test hole for testing. Excessive liquid inside the predetermined-volume chamber flows out of the predetermined-volume chamber through the overflow hole on the bottom surface of the predetermined-volume chamber and be absorbed by the suction strip, which prevents leakage due to excessive reagent.

### CROSS REFERENCE TO RELATED APPLICATION

This application claims priority to Chinese application no. 202320235749.9 filed on Feb. 16, 2023, which Issued on Jun. 16, 2023 as CN219201385U, the entire disclosure of which is incorporated herein by reference.

### TECHNICAL FIELD

The present disclosure relates to the field of testing technology, and more specifically, relates to a predetermined-volume test reagent box.

### BACKGROUND

The hemoglobin in feces, also known as fecal occult blood, is currently regarded as one of the tumor markers for rectal and colon cancer in clinical practice, and is also a very useful diagnostic indicator. Fecal occult blood is an early warning of digestive tract abnormalities. When the amount of bleeding is small, the appearance of the feces may not have any indicative changes and cannot be recognized by the naked eye. Therefore, it is usually necessary to use testing reagents to test the fecal samples before making a judgment on the condition of the samples. The known test method is to use a sampling head to take the sample, and then add a mixed liquid of the sample and reagent to the test paper for reaction testing. However, most existing test kits have difficulty in controlling the amount of mixed liquid in contact with the test strip during testing. When the amount of mixed liquid is too small, it will affect the test results of the test strip. When the amount of mixed liquid is excessive, it is easy to cause sample leakage and environmental pollution. Therefore what is needed is testing kit that can control the amount of mix liquid in contact with the test strip during testing.

### SUMMARY

In accordance with various embodiments and aspects of the present disclosure, an apparatus is disclosed in the form of a testing kit that controls the amount of mix liquid in contact with the test strip during testing.

In accordance with various embodiments and aspects of the present disclosure a predetermined-volume test reagent box is disclosed that solves the problem of difficulty in grasping the amount of mixed liquid in contact with the test strip during the testing of existing testing reagent kits.

In accordance with various embodiments and aspects of the present disclosure, the technical solution adopted by this utility model is to provide a predetermined-volume test reagent box that includes any combination of the following:
A main box body, equipped with a sampling head and a leakage hole at one end, and a predetermined-volume chamber is internally set. The first end of the predetermined-volume chamber is connected to the leakage hole, and a test hole is set at the second end. The bottom surface of the predetermined-volume chamber is equipped with an overflow hole to prevent excessive mixed reagent, and the overflow hole is spaced with the test hole;
A test strip, arranged inside the main box body, and the test strip is arranged along the length direction of the main box body. The end of the test strip extends into the predetermined-volume chamber through the test hole;
A suction strip, located inside the main box and spaced with the test strip, for absorbing and accommodating excess reagent. One end of the suction strip extends into the interior of the predetermined-volume chamber through the overflow hole;
An end cap, located at the end of the main box body, with a piston cap internally arranged to accommodate reagent.

In one possible embodiment, the main box is further equipped with a support partition inside, the test strip and the suction strip are respectively arranged on both sides of the support partition, and the predetermined-volume chamber and the test strip are arranged on the same side of the support partition.

In one possible embodiment, an opening is provided at the end of the main box body, and an installation disk body is also covered at the end of the main box body. The outer side of the installation disk body is also provided with a receiving groove, and the sampling head and leakage hole are both arranged at the bottom of the receiving groove.

In one possible embodiment, the end of the support partition is supported against the inner side of the installation disc, and the support partition and the installation disc are formed into an integrated structure.

In one possible embodiment, connecting channels are also provided between the opening of the predetermined-volume chamber and the leakage hole, and the connecting channels match the number of leakage holes.

In one possible embodiment, the inner wall containing the groove is further provided with multiple blocking columns, and the opening of the connecting channels is also provided with blocking columns.

In one possible embodiment, the first end of the quantitative chamber is conical, the test hole is set at the end of the conical, and a liquid retaining wall is also set at the test hole, and both ends of the liquid retaining wall are spaced with the inner wall of the predetermined-volume chamber.

In one possible embodiment, the bottom surface of the predetermined-volume chamber is an inclined plane, which is inclined from the first end of the predetermined-volume chamber to its second end.

In one possible embodiment, a clamping structure is also provided between the end of the main box body and the end cover to connect the main box body and the end cover.

In one possible embodiment, the clamping structure comprises an installation convex ring arranged at the end of the main box body and resting against the inner wall of the end cover, a clamping protrusion arranged on the inner wall of the end cover, and a clamping groove arranged outside the installation convex ring.

The benefits of the predetermined-volume test reagent box provided by this utility model is that, compared with the prior art, it mainly includes two parts: a main box body and an end cover. A sampling head and a leakage hole are set at the end of the main box body, and a predetermined-volume chamber is set inside the main box body. The first end of the predetermined-volume chamber is connected to the leakage hole and a test hole is set at the second end. The bottom surface of the predetermined-volume chamber is provided with an overflow hole for preventing excessive mixed reagents, and the overflow hole is spaced apart from the test hole. The interior of the main box body is also equipped with a test strip and a suction strip. The end of the test strip extends into the predetermined-volume chamber through the test hole, and one end of the suction strip extends into the interior of the predetermined-volume chamber through the overflow hole. The predetermined-volume test reagent box of this utility model can be used for sample testing. After taking sample through the sampling head, the end cover is set at the end of the main box body, and the sampling head is inserted into the piston cap inside the end cover to mix with the reagent. Then, by flipping the main box body and end cover (usually the predetermined-volume chamber is flipped to a vertical state, and the test hole is located at the bottom), the mixed reagent flows into the predetermined-volume chamber through the leakage hole, and the mixed reagent contacts the test strip at the test hole for testing. When there is too much liquid inside the predetermined-volume chamber, it will flow out of the predetermined-volume chamber through the overflow hole on the bottom surface of the predetermined-volume chamber and be absorbed by the suction strip, which can prevent environmental pollution caused by excessive leakage of reagents from the predetermined-volume chamber.

### BRIEF DESCRIPTION OF THE DRAWINGS

In order to provide a clearer explanation of the technical solution in the embodiments of the present utility model, a brief introduction will be given to the accompanying drawings required in the embodiments or existing technical descriptions. It is evident that the accompanying drawings in the following description are only some embodiments of the present utility model. For average technicians in the field, other accompanying drawings can be obtained based on these drawings without creative effort.

FIG. 1 is a structural diagram of the predetermined-volume test reagent box provided in accordance with various embodiments and aspects of the present invention;

FIG. 2 is an explosive structure diagram of the predetermined-volume test reagent box provided in accordance with various embodiments and aspects of the present invention;

FIG. 3 is a partial cross-sectional structural diagram of the predetermined-volume test reagent box provided in accordance with various embodiments and aspects of the present invention;

FIG. 4 is a schematic diagram of the structure of the installation disc body in accordance with various embodiments and aspects of the present invention.

Legend of the accompanying figures: 1. Main box body; 2. Test strip; 3. Suction strip; 4. Predetermined-volume chamber; 401. Test hole; 402. Overflow hole; 5. End cover; 6. Support partition; 7. Installation disc body; 8. Leakage hole; 9. Sampling head; 10. Connecting channels; 11. Clamping structure; 111. Installation convex ring; 112. Clamping protrusion.

### DETAILED DESCRIPTION

Various inventive features are described below that can each be used independently of one another or in combination with other features. However, any single inventive feature may not address any of the problems discussed above or may only address one of the problems discussed above.

It is noted that, as used herein, the singular forms “a,” “an” and “the” include plural referents unless the context clearly dictates otherwise. Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

The following describes various examples of the present technology that illustrate various aspects and embodiments of the invention. Generally, examples can use the described aspects in any combination. The description is not to be taken in a limiting sense, but it is made merely for the purpose of illustrating the general principles of the disclosure, since the scope of the disclosure is best defined by the appended claims. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

In order to make the technical problems, technical solutions, and beneficial effects to be solved by this utility model clearer, the following is a further detailed explanation of this utility model in conjunction with the accompanying figures and embodiments. It should be understood that the specific embodiments described here are only intended to explain the present utility model instead of limiting it.

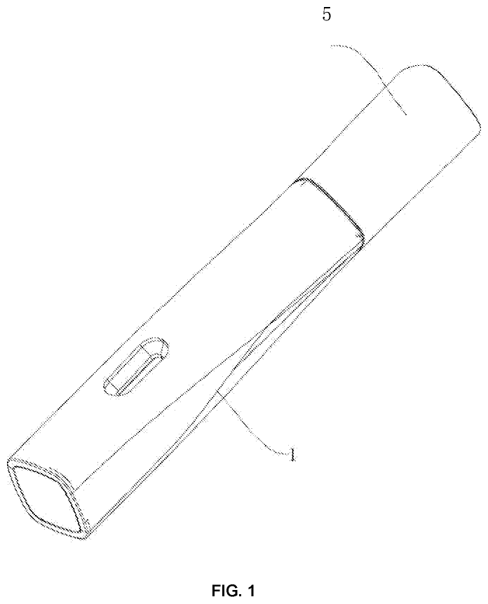

Referring now to FIG. 1 to FIG. 4 together, which illustrate the predetermined-volume test reagent box provided by this utility model. The predetermined-volume test reagent box includes a main box body 1, a test strip 2, a suction strip 3, and an end cover 5. A sampling head 9 and a leakage hole 8 are arranged at one end of the main box body 1, and a predetermined-volume chamber 4 is internally arranged. The first end of the predetermined-volume chamber 4 is connected to the leakage hole 8, and a test hole 401 is arranged at the second end. The bottom surface of the predetermined-volume chamber 4 is equipped with an overflow hole 402 for preventing excessive mixed reagents, and the overflow hole 402 is spaced apart from the test hole 401; The test strip 2 is arranged inside the main box body 1, and the test strip 2 is arranged along the length direction of the main box body 1. The end of the test strip 2 extends into the predetermined-volume chamber 4 through the test hole 401; The suction strip 3 is arranged inside the main box body 1 and spaced with the test strip 2 to absorb and accommodate excess reagents. One end of the suction strip 3 extends into the interior of the predetermined-volume chamber 4 through the overflow hole 402; The end cover 5 is located at the end of the main box body 1, and a piston cap is arranged inside to accommodate the reagent.

In accordance with various embodiments and aspects of the present disclosure, this predetermined-volume test reagent box provided in this embodiment mainly includes two parts, the main box body 1 and the end cover 5. A sampling head 9 and a leakage hole 8 are arranged at the end of the main box body 1, and a predetermined-volume chamber 4 is arranged inside the main box body 1. The first end of the predetermined-volume chamber 4 is connected to the leakage hole 8, and a test hole 401 is arranged at the second end, and the bottom surface of the predetermined-volume chamber 4 is provided with an overflow hole 402 to prevent excessive mixed reagents, The overflow hole 402 is spaced with the test hole 401. The interior of the main box body 1 is also equipped with a test strip 2 and a suction strip 3. The end of the test strip 2 extends into the predetermined-volume chamber 4 through the test hole 401, and the end of the suction strip 3 extends into the interior of the predetermined-volume chamber 4 through the overflow hole 402. The predetermined-volume test reagent box of this utility model can be used for sample testing. After taking sample through the sampling head 9, the end cover 5 can be placed at the end of the main box body 1, and the sampling head 9 can be inserted into the piston cap inside the end cover 5 to mix with reagent. Then, by flipping the main box body 1 and end cover 5 (usually the predetermined-volume chamber 4 will be flipped to a vertical state, and the test hole 401 is located at the bottom), the mixed reagent will flow into the predetermined-volume chamber 4 through the leakage hole 8, and the mixed reagent will be tested by contacting the test strip 2 at the test hole 401. When there is too much liquid inside the predetermined-volume chamber 4, it will flow out of the predetermined-volume chamber 4 through the overflow hole 402 on the bottom surface of the predetermined-volume chamber 4 and be absorbed by the suction strip 3, which can prevent environmental pollution caused by excessive leakage of reagents in predetermined-volume chamber 4.

It should be noted that the bottom surface of the predetermined-volume chamber 4 here refers to the positional relationship of the main box 1 when placed horizontally, and is only a name limitation rather than a direction specification.

During a test, the main box 1 will generally flip into a vertical state, and the bottom surface of the predetermined-volume chamber 4 will be in a vertical state. The overflow hole 402 is spaced from the test hole 401, and the maximum capacity of the predetermined-volume chamber 4 can be controlled by the distance between the overflow hole 402 and the test hole 401. The control piston cap is clamped inside the end cap 5, and the reagent is encapsulated inside the piston cap, which is sealed at the mouth of the piston cap through an al-plastic film, and mixed with the reagent after puncturing the aluminum plastic film through the sampling head 9. And the suction strip 3 is usually made of absorbent materials such as absorbent paper or cotton strips, and is fixed inside the main box body 1.

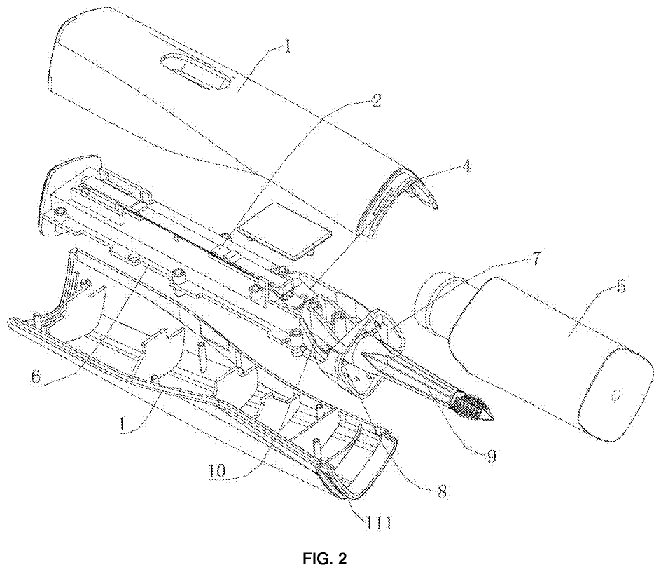

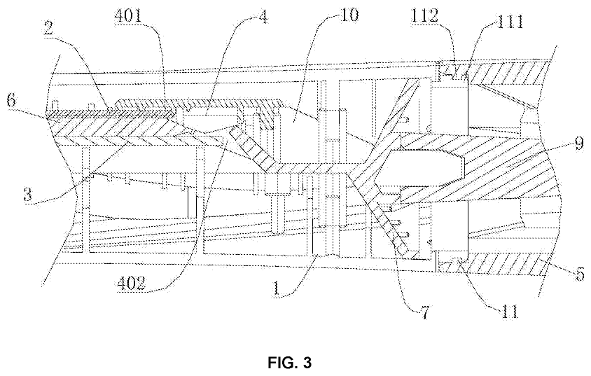

In some possible embodiments, as shown in FIGS. 2 and 3, there is also a support partition 6 inside the main box body 1. The test strip 2 and the suction strip 3 are respectively arranged on both sides of the support partition 6, and the predetermined-volume chamber 4 and the test strip 2 are arranged on the same side of the support partition 6. Specifically, the support partition 6 is arranged along the axial direction of the main box body 1, dividing the interior of the main box body 1 into two independent areas. The setting of the support partition 6 can separate the test strip 2 from the suction strip 3, preventing the overflow of unwanted liquid from interfering with the testing of the test strip 2, and also making the installation of the test strip 2 and the suction strip 3 more convenient. The predetermined-volume chamber 4 is surrounded by a retaining wall arranged on the side of the support partition 6 (the retaining wall is generally injection molded with the support partition 6), and the bottom surface of the predetermined-volume chamber 4 is the side of the support partition 6. The top surface opening of the predetermined-volume chamber 4 can be sealed by pressing against the inner wall of the main box 1, or by covering the top opening of the predetermined-volume chamber 4 with a quantitative cell cover plate. The quantitative cell cover plate is generally made of absorbent material, such as absorbent paper or water washing cotton.

In order to make it more convenient for the mixed reagent to flow into the predetermined-volume chamber 4, as shown in FIGS. 2 and 3, an opening is provided at the end of the main box 1, and an installation disc 7 is also covered at the end of the main box 1. The outer side of the installation disc 7 is also provided with a receiving groove, and the sampling head 9 and the leakage hole 8 are both set at the bottom of the receiving groove. Specifically, one end of the sampling head 9 is fixed at the bottom of the receiving groove and the other end extends away from the end of the main box 1. The sampling head 9 is located in the middle of the receiving groove and the leakage hole 8 is located on both sides of the sampling head 9, making overall assembly more convenient.

As a preferred option, there is also an observation hole on the side of the main box body 1 for observing the results displayed on the test strip 2, which allows for convenient observation of the test results. The bottom surface of the containing groove can be composed of two inclined planes at an angle to each other, which facilitates the mixing of reagents into the predetermined-volume chamber 4 after the main box body 1 is vertical through the leakage hole 8 located at the bottom of the containing groove, which can make testing more convenient and efficient.

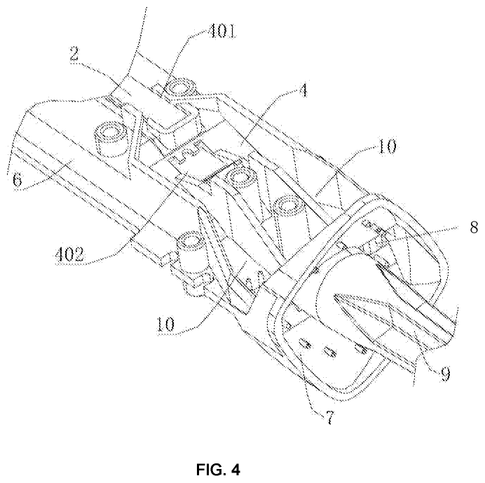

As shown in FIG. 4, the end of the support partition 6 is against the inner side of the installation disc 7, and the support partition 6 and the installation disc 7 are integrated into a formed structure. Specifically, the integrated formation of the support partition 6 and the installation disk 7 allows the retaining wall surrounding the predetermined-volume chamber 4 on the side of the support partition 6 to be directly connected to the side of the installation disk 7, preventing the gap between the predetermined-volume chamber 4 and the leakage hole 8 from causing reagent leakage and making sample testing safer.

In addition, the main box body 1 generally adopts a split structure, which can be divided into an upper shell and a lower shell. The support partition plate 6 and the installation disc 7 can be covered between the upper shell and the lower shell, making installation more convenient.

On the basis of the above characterized predetermined-volume chamber 4, as shown in FIGS. 3 and 4, connecting channels 10 are also set between the opening of the predetermined-volume chamber 4 and the leakage hole 8, and the number of connecting channels 10 matches the leakage hole 8. Specifically, the setting of connection channels 10 can delay the time for the reagent to flow into the pre-determined chamber 4, making the operation simpler. Simultaneously connecting the setting of channels 10 can make the position setting of predetermined-volume chamber 4 more flexible.

As preferred, as shown in FIG. 4, multiple blocking columns are also provided on the inner wall of the groove, and the mouth of the connecting channels 10 is also provided with blocking columns. Specifically, the spacing between the blocking columns is set on the inner wall of the containing groove and the mouth of the connecting channels 10, which can block foreign objects in the sample and prevent them from entering the interior of the predetermined-volume chamber 4, which could affect the testing results of the test strip 2.

In some possible embodiments, as shown in FIG. 4, the first end of the pre-determined chamber 4 is conical, and the test hole 401 is set at the end of the conical shape. The test hole 401 is also equipped with a liquid retaining wall, and both ends of the liquid retaining wall are spaced with the inner wall of the predetermined-volume chamber 4. Specifically, the first end of the predetermined chamber 4 is conical, which can be flipped vertically in the main box 1, making it more convenient for the reagent to flow and concentrate at the test hole 401. The setting of the liquid retaining wall can prevent a large amount of liquid from suddenly pouring into the test hole 401 to form a leak, thus ensuring accurate testing.

Based on the above characterized predetermined-volume chamber 4, as shown in FIG. 4, the bottom surface of the predetermined-volume chamber 4 is an inclined plane, which tilts from the first end of the predetermined-volume chamber 4 to its second end. Specifically, the overflow hole 402 is arranged on the inclined surface mentioned above, and the bottom surface of the predetermined-volume chamber 4 is an inclined surface, which makes it more convenient for the reagent to concentrate towards the test hole 401.

In some possible embodiments, as shown in FIG. 3, a clamping structure 11 is also provided between the end of the main box body 1 and the end cover 5 to connect the main box body 1 and the end cover 5. Specifically, the setting of the clamping structure 11 can improve the sealing between the main box body 1 and the end cover 5, and prevent the leakage of mixed reagents during flipping.

The above feature adopts the structure shown in FIG. 3. As shown in FIG. 3, the clamping structure 11 includes an installation convex ring 111 arranged at the end of the main box body 1 and resting against the inner wall of the end cover 5, a clamping protrusion 112 arranged on the inner wall of the end cover 5, and a clamping groove arranged at the end of the installation convex ring 111. During the installation of end cover 5, the outer wall of the installation convex ring 111 can be pressed against the inner wall of the end cover 5 to form a seal. At the same time, the clamping protrusion 112 will be clamped inside the installation convex ring 111 to prevent the end cover 5 from detaching from the installation convex ring 111, making the connection between the two tighter for better sealing.

The above are only some preferred embodiments of this utility model and are not intended to present any limitation. Any modifications, equivalent replacements, and improvements made within the spirit and principles of this utility model should be included in the scope of protection of this utility model. Certain examples have been described herein and it will be noted that different combinations of different components from different examples may be possible. Salient features are presented to better explain examples; however, it is clear that certain features may be added, modified and/or omitted without modifying the functional aspects of these examples as described.

It should be understood, of course, that the foregoing relates to exemplary embodiments of the invention and that modifications may be made without departing from the scope of the invention. The scope of the invention, therefore, is not intended to be limited to the exemplary embodiments shown and described herein. Rather, the scope and spirit of present invention is embodied by the appended claims.

What is claimed is:

1. A predetermined-volume test reagent box comprising:
a main box body having:
a sampling head;
a leakage hole at one end; and
a predetermined-volume chamber,
wherein a first end of the predetermined-volume chamber is connected to the leakage hole,
wherein a second end of the predetermined-volume chamber includes a test hole,
wherein a bottom surface of the predetermined-volume chamber includes an overflow hole to prevent excessive mixed reagent and the overflow hole is spaced from the test hole,
wherein a test strip is arranged inside the main box body such that the test strip is arranged along a length direction of the main box body and an end of the test strip extends into the predetermined-volume chamber through the test hole,
wherein a suction strip is arranged inside the main box body and spaced with the test strip to absorb and accommodate excess reagent and one end of the suction strip extends into an interior of the predetermined-volume chamber through the overflow hole,
wherein an end cover is arranged at the end of the main box body,
wherein a piston cap is arranged inside to accommodate reagent.

2. The predetermined-volume test reagent box of claim 1, wherein the main box body includes a support partition inside and the test strip and the suction strip are respectively arranged on both sides of the support partition, and wherein the predetermined-volume chamber and the test strip are arranged on a same side of the support partition.

3. The predetermined-volume test reagent box as described in claim 2, wherein an opening is provided at the end of the main box body, wherein an installation disk body is covered at the end of the main box body, wherein an outer side of the installation disk body includes a receiving groove, wherein the sampling head and the leakage hole are both arranged at a bottom of the receiving groove.

4. The predetermined-volume test reagent box as described in claim 3, wherein the end of the support partition rests against an inner side of the installation disk body, and the support partition and the installation disk body are formed into an integrated structure.

5. The predetermined-volume test reagent box as described in claim 3, wherein connecting channels are provided between an opening of the predetermined-volume chamber and the leakage hole, and wherein the connecting channels match the number of leakage holes.

6. The predetermined-volume test reagent box as described in claim 5, wherein an inner wall of a containing groove includes multiple blocking columns, and wherein an opening of the connecting channels are also provided with blocking columns.

7. The predetermined-volume test reagent box as described in claim 1, characterized in that the first end of the predetermined-volume chamber is conical, wherein the test hole is set at the end of the conical, and a liquid retaining wall is set at the test hole, and wherein both ends of the liquid retaining wall are spaced with an inner wall of the predetermined-volume chamber.

8. The predetermined-volume test reagent box as described in claim 2, wherein a bottom surface of the predetermined-volume chamber is an inclined plane and the inclined plane is inclined from a first end of the predetermined-volume chamber to a second end of the predetermined-volume chamber.

9. The predetermined-volume test reagent box as described in claim 1, wherein a clamping structure is also provided between an end of the main box body and an end cover for connecting the main box body and the end cover.

10. The predetermined-volume test reagent box as described in claim 9, wherein the clamping structure includes an installation convex ring arranged at an end of the main box body and rests against an inner wall of the end cover, wherein a clamping protrusion arranged on the inner wall of the end cover, and wherein a clamping groove is arranged outside the installation convex ring.
